(19) United States
(12) Patent Application Publication
(10) Pub. No.: US 2024/0331422 A1
(43) Pub. Date: Oct. 3, 2024

(54) RECOGNITION DEVICE, RECOGNITION METHOD, AND RECOGNITION PROGRAM

(71) Applicant: NIPPON TELEGRAPH AND TELEPHONE CORPORATION, Tokyo (JP)

(72) Inventors: Kohei MORI, Tokyo (JP); Yuki YOKOHATA, Tokyo (JP); Aki HAYASHI, Tokyo (JP); Takahiro HATA, Tokyo (JP); Kazuaki OBANA, Tokyo (JP)

(73) Assignee: NIPPON TELEGRAPH AND TELEPHONE CORPORATION, Tokyo (JP)

(21) Appl. No.: 18/292,175

(22) PCT Filed: Jul. 29, 2021
(86) PCT No.: PCT/JP2021/028191

§ 371 Date: Jan. 25, 2024

(51) Int. Cl. G06V 30/19; G06T 7/70; G06V 20/58; G06V 20/62; G06V 30/182

(52) U.S. Cl. CPC G06V 30/19013; G06T 7/70; G06V 20/58; G06V 20/625; G06V 30/1834

(57) ABSTRACT

A recognition device acquires a time-series image acquired in an environment in which a vehicle travels, detects characters of a predetermined character string from the image, and evaluates relationship between detected characters of the character string and recognizes a shape of a target including the character string.

### TECHNICAL FIELD

The disclosed technology relates to a recognition device, a recognition method, and a recognition program.

### BACKGROUND ART

There is a technology of recognizing a shape of another object appearing in a video of an in-vehicle camera such as a drive recorder.

Here, it is assumed that a problem vehicle that repeats dangerous behavior such as road rage is observed for another object. A technology of automatically detecting a problem vehicle in a case where the vehicle enters a detection area has been developed (see Non Patent Literature 1). It is assumed that the problem vehicle repeats dangerous behavior at another point, at another time, and to another vehicle. Therefore, it is considered that notifying other vehicles that the vehicle is dangerous is highly necessary. For this purpose, obtaining information that can identify the vehicle is important. However, the vehicle that repeats dangerous behavior is less likely to provide position information, a behavior history, a video of the inside of the vehicle, and the like as the information that enables identification, and identification needs to be performed from the outside.

In order to identify a vehicle, for example, a vehicle type, a color of a vehicle body, and a number written on an automobile registration number tag (license plate) are useful information for identification. FIG. 1 is a diagram schematically illustrating a case where another vehicle is observed from an observation vehicle. As illustrated in FIG. 1, it is assumed that another vehicle (A2) is observed from an observation vehicle (A1) and a shape of a license plate (A3) of the another vehicle is recognized as a target. Furthermore, there is a possibility that a vehicle of the same vehicle type or the same color exists in the vicinity of a problem vehicle, and a number needs to be identified in order to uniquely identify the problem vehicle.

### CITATION LIST

### Non Patent Literature

Non Patent Literature 1: “KENWOOD, aori unten wo jido kenchi suru “AI sensing” kino tosai dorareko “DRV-MR8500” (KENWOOD, drive recorder “DRV-MR8500” with “AI sensing” function for automatically detecting tailgating)”, URL: “https://car.watch.impress.co.jp/docs/news/1266971.html”
Non Patent Literature 2: “Number plate ninshiki (License plate recognition)”, URL: “https://www.jstage.jst.go.jp/article/isciesci/43/6/43_KJ00 003974529/_article/-char/ja/”
Non Patent Literature 3: “Real-Time Brazilian License Plate Detection and Recognition Using Deep Convolutional Neural Networks”, URL: “http://www.inf.ufrgs.br/˜smsilva/real-time-brazilian-alpr/”
Non Patent Literature 4: “Kokudo kotsusyo/chiho ban zugara iri number plate (the Ministry of Land, Infrastructure, Transport and Tourism/license plate with local plate design)”, URL: “https://www.mlit.go.jp/jidosha/jidosha_tk6_000036.html”

### SUMMARY OF INVENTION

### Technical Problem

As an existing technology, a technology of detecting a license plate by an object detection technology and reading characters described thereon has been proposed (see Non Patent Literature 2 and Non Patent Literature 3). This is a method of performing front/rear detection, and performing processing in stages of license plate detection and character recognition (character detection).

FIG. 2 is a diagram illustrating a general flow of processing from detection to recognition of a license plate. This is a flow of (1) video (time-series image) acquisition, (2) license plate detection, (3) region division, and (4) character recognition (optical character recognition or object detection) for each region. In the license plate detection, for example, object detection, or contour extraction by binarization and detection from a quadrangular shape are performed. Furthermore, the detection accuracy may be improved by object detection of a vehicle being interposed before (2). Furthermore, inclination correction may be performed before (3) so that the shape of the region is made rectangular.

Here, since recognition of a license plate is composed of 26 alphabets+10 numbers in the alphabet-using countries assumed in Non Patent Literature 3, and a character string that is main is often represented in a large line, it is assumed that character recognition is relatively easy. However, in a country having a form of a localized license plate such as Japan or China, characters including hiragana characters and Chinese characters divided into a plurality of columns need to be recognized, and a case where patterns are complicated is assumed. Furthermore, in the example of Non Patent Literature 3, three-stage object detection is performed, and the calculation cost is large.

For example, there are a case where the size of some characters is small, a case where Chinese characters are included, a case where some digits of 1 to 3 digits are alphabets, a case where there is one character in hiragana, a case where a dot (⋅) is included, and the like. Examples of the case where a dot is included include a case where the number is 3 digits or less, such as “⋅1-43”. Furthermore, there is a plurality of types of backgrounds according to the classification such as general use or business use, ordinary vehicle or light vehicle, and out-of-inspection, and the background of a license plate is determined regardless of the color of the vehicle body. Furthermore, variations in the background are increasing due to the influence of a local license plate unique to a region (see Non Patent Literature 4). As described above, there are issues related to recognition of a license plate.

Furthermore, unlike an expensive high-performance camera, in an in-vehicle camera, the influence of blurring of the subject, that is, blurring caused by the influence of the relative speed between an observation vehicle and a target vehicle increases. Since capturing conditions including exposure, reflection, and the like are mainly different each time, there is a case where recognition is difficult by a conventional method.

For example, since there is no relationship between a vehicle body color and a license plate, in a case where the license plate and the vehicle body color are similar to each other, the boundary is unclear, and it is assumed that object detection and shape recognition are difficult. For example, a case where a white or silver vehicle body has a white license plate, a case where a black vehicle body has a black license plate, and the like are assumed. Furthermore, even if the region of a license plate is enlarged, a portion other than the number “XX-XX” may not be clear in some cases. As described above, there are issues related to blurring of the subject.

The disclosed technology has been made in view of the above circumstances, and an object thereof is to provide a recognition device, a recognition method, and a recognition program for enabling evaluation of detected characters and recognition of a target even in a case where a specific target is difficult to be recognized.

### Solution to Problem

A first aspect of the present disclosure is a recognition device including an acquisition unit that acquires a time-series image acquired in an environment in which a vehicle travels, a detection unit that detects characters of a predetermined character string from the image, and a shape recognition unit that evaluates relationship between detected characters of the character string and recognizes a shape of a target including the character string.

A second aspect of the present disclosure is a recognition method for causing a computer to execute processing, the processing including acquiring a time-series image acquired in an environment in which a vehicle travels, detecting characters of a predetermined character string from the image, and evaluating relationship between detected characters of the character string and recognizing a shape of a target including the character string.

A third aspect of the present disclosure is a recognition program for causing a computer to execute processing, the processing including acquiring a time-series image acquired in an environment in which a vehicle travels, detecting characters of a predetermined character string from the image, and evaluating relationship between detected characters of the character string and recognizing a shape of a target including the character string.

### Advantageous Effects of Invention

According to the disclosed technology, even in a case where a specific target is difficult to be recognized, detected characters can be evaluated and a target can be recognized.

### BRIEF DESCRIPTION OF DRAWINGS

FIG. 1 is a diagram schematically illustrating a case where another vehicle is observed from an observation vehicle.

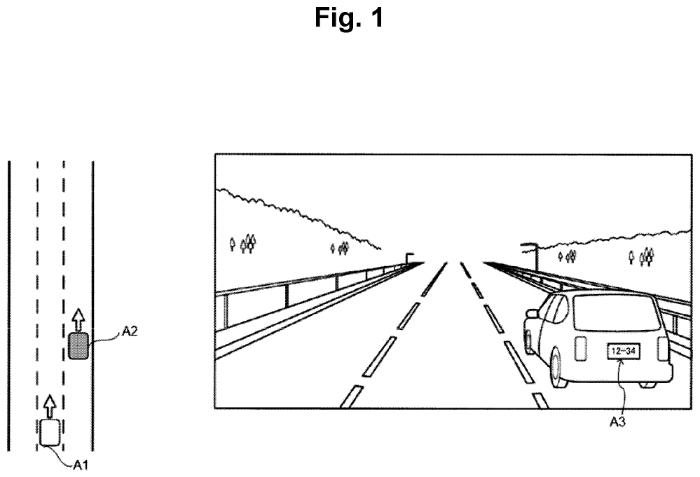

FIG. 2 is a diagram illustrating a general flow of processing from detection to recognition of a license plate.

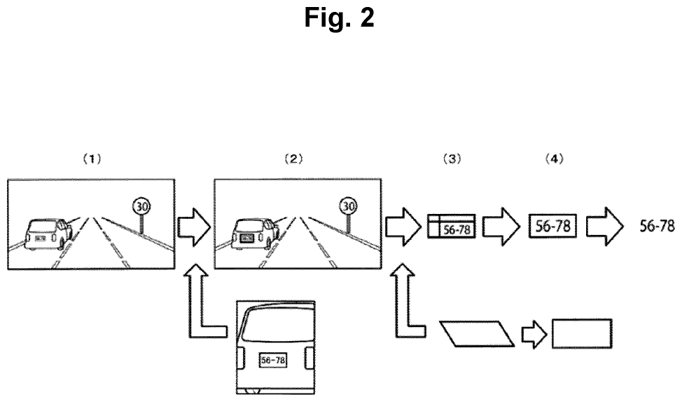

FIG. 3 is a diagram illustrating an example of a flow of recognition of a license plate according to the present embodiment.

FIG. 4 is a diagram illustrating an example in an image regarding a condition regarding selection of a character string.

FIG. 5 is a diagram for describing relationship between a camera and how an object appears in an image.

FIG. 6 is a block diagram illustrating a hardware configuration of a recognition device.

FIG. 7 is a block diagram illustrating a functional configuration of the recognition device of the present embodiment.

FIG. 8 is a diagram illustrating an example of a case where detection is performed from an image by detection rectangles.

FIG. 9 is a diagram illustrating an example of information of coordinates of detected detection rectangles.

FIG. 10 is a flowchart illustrating a flow of recognition processing by the recognition device.

### DESCRIPTION OF EMBODIMENTS

Hereinafter, an example of an embodiment of the disclosed technology will be described with reference to the drawings. In the drawings, the same or equivalent components and parts will be denoted by the same reference signs. Further, dimensional ratios in the drawings are exaggerated for convenience of description and may be different from actual ratios.

First, an overview of the present disclosure will be described. Hereinafter, in the example described in the present embodiment, a case where a shape is recognized using a license plate of a target vehicle captured from an observation vehicle as a target will be described. In a method of the present embodiment, a pattern or a shape corresponding to a license plate is not detected, but a pattern in which a character string corresponding to a license plate is drawn is recognized as a number, and a region in which the pattern of the character string is present is recognized as a license plate. Hereinafter, the description regarding a character string is assumed to represent a pattern of the character string. This is because no matter what color and design the background of the license plate is, the drawn character string follows the description rule of a license plate. Furthermore, hereinafter, a portion of a character string of a license plate may be described as a number, and the license plate itself as an object may be described as a plate. Note that the method of the present embodiment can be applied not only to a license plate but also to a feature on which a sign and other characters are drawn.

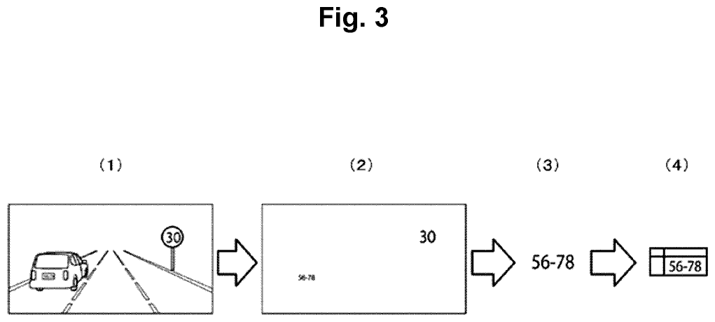

FIG. 3 is a diagram illustrating an example of a flow of recognition of a license plate according to the present embodiment. For example, a license plate is detected in the general example described in the problem, but in the method of the present embodiment, (1) a video (time-series image) is acquired, and then (2) characters are detected and characters corresponding to the license plate are selected. As the character selection, for example, a character string of a license plate is selected under conditions that four numbers are present at prescribed intervals, the height is substantially uniform, and the character string is present below the vanishing point of the image. Furthermore, (3) the region is enlarged instead of region division. Then, (4) the close region is combined with a result of character recognition. As a result, even if a license plate and a vehicle body color are similar and the boundary is ambiguous, the boundary line can be assumed. Furthermore, even in a case where the background is specialized like a license plate unique to a region, the case can be coped with without additional learning or the like required.

In the following description of the embodiment, description will be given focusing on a portion of “XX-XX” that is a character string of a number portion of a license plate. Considering the particularity of the font and the description rule, it is assumed that the license plate can be recognized only by the portion “XX-XX”. A license plate is restricted, and a position to be installed, an angle, an arrangement in the plate, and the like are restricted. Note that, in the present embodiment, the definition of characters of a character string includes numbers, symbols, hiragana, and Chinese characters.

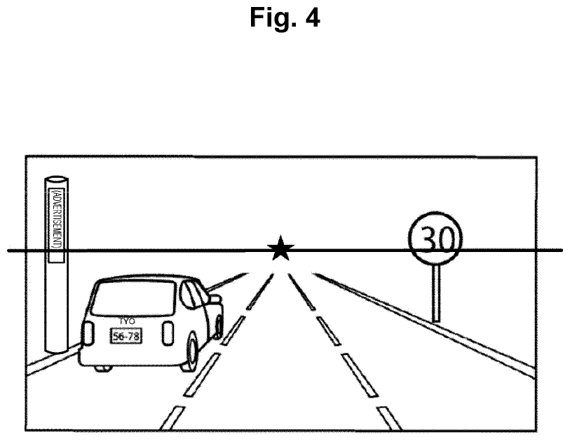

FIG. 4 is a diagram illustrating an example in an image regarding a condition regarding selection of a character string. For example, detection may be limited to a region below the vanishing point, or detection of a character string may be performed targeting the lower half of an image. Furthermore, only 0 to 9 and a dot appear in the portion of “XX-XX”, and thus, in a case of an in-vehicle camera that captures the front or rear of the vehicle, the character string appears in an image in the horizontal direction at specific intervals. Furthermore, in a case where a plurality of alphabetical characters is arranged, the characters can be determined not to be a number. Furthermore, in a case where a special font is used, narrowing down is possible also by the font. Furthermore, a vertical character string in an advertisement or the like of a utility pole may be excluded from detection.

An existing technology utilized in the present embodiment will be described.

For detection of each character of a character string, for example, an object detection technology described in Reference Literature 1 is utilized. In this technology, for example, an object and each character of alphabets and numbers are detected from an image, and coordinate information (upper left XY coordinates and lower right XY coordinates of rectangles) on circumscribed rectangular images is output, and each character of a character string can be detected. [Reference Literature 1] “YOLO: Real-Time Object Detection”, URL: “https://pjreddie.com/darknet/yolo/”

Furthermore, the principle of a camera as described in Reference Literature 2 is utilized. [Reference Literature 2] “Proximity”, URL: “http://www.persfreaks.jp/main/intro/pers/”

In a case where a monocular camera such as a general in-vehicle camera is used, a feature such as another vehicle or a building is drawn so as to converge with respect to the vanishing point. Furthermore, in a case where an image that is not easily affected by lens distortion is used, such as a case where a non-wide-angle lens is used or a case where a region having less distortion of a wide-angle lens is cut out, the size of an object appearing in an image can be approximated as in a perspective view, and changes according to a law with respect to a distance from a reference point.

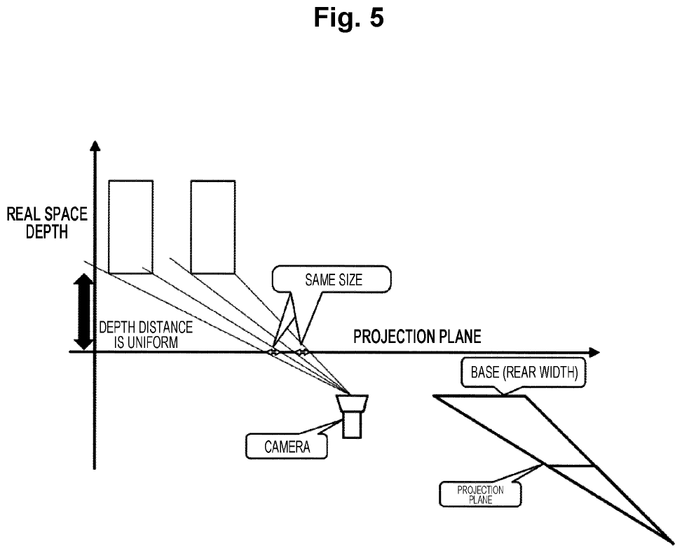

FIG. 5 is a diagram for describing relationship between a camera and how an object appears in an image. Assuming that the camera captures the front or rear of another vehicle straight, the front or rear of the vehicle body appears in the image with the same size if a plane parallel to the projection plane, that is, the distance in the depth direction is the same. This is because the camera and the projection plane can be expressed by similarity of a triangle, and the length and the height of the base have the same value. That is, no matter how many lanes the in-vehicle camera mounted on the observation vehicle is away from another vehicle from which the number is to be read, characters of the license plate itself appear in the same manner.

On the basis of the above, the configuration of the present embodiment will be described.

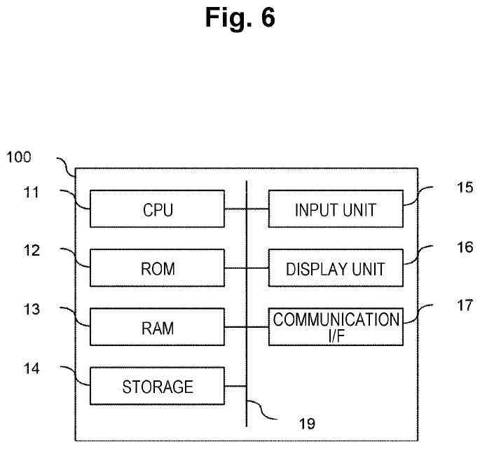

FIG. 6 is a block diagram illustrating a hardware configuration of a recognition device 100.

As illustrated in FIG. 6, the recognition device 100 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit, and executes various programs and controls each unit. That is, the CPU 11 reads the programs from the ROM 12 or the storage 14 and executes the programs by using the RAM 13 as a work region. The CPU 11 controls the components described above and performs various types of calculation processing according to the program stored in the ROM 12 or the storage 14. In the present embodiment, a recognition program is stored in the ROM 12 or the storage 14.

The ROM 12 stores various programs and various types of data. The RAM 13 serving as a working region temporarily stores programs or data. The storage 14 includes a storage device such as a hard disk drive (HDD) or a solid state drive (SSD) and stores various programs including an operating system and various types of data.

The input unit 15 includes pointing devices such as a mouse and a keyboard and is used to execute various inputs.

The display unit 16 is, for example, a liquid crystal display and displays various types of information. The display unit 16 may function as the input unit 15 by employing a touchscreen system.

The communication interface 17 is an interface communicating with another device such as a terminal. For the communication, for example, a wired communication standard such as Ethernet (registered trademark) or FDDI, or a wireless communication standard such as 4G, 5G, or Wi-Fi (registered trademark) is used.

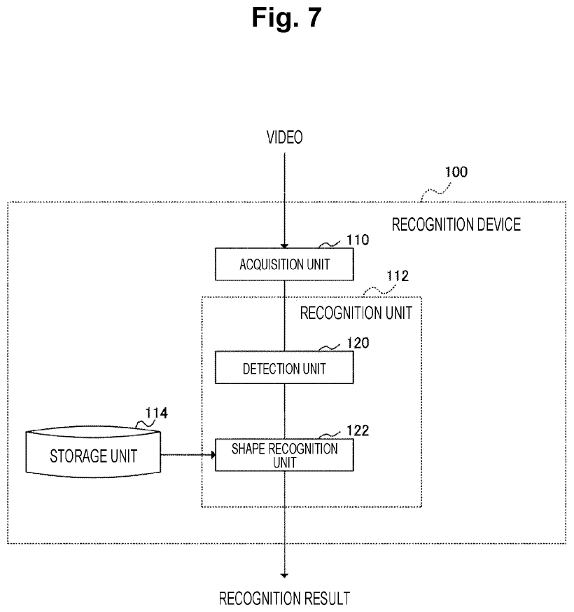

Next, each functional unit of the recognition device 100 will be described. FIG. 7 is a block diagram illustrating a functional configuration of the recognition device of the present embodiment. Each functional unit is implemented by the CPU 11 reading the recognition program stored in the ROM 12 or the storage 14, developing the recognition program in the RAM 13, and executing the recognition program.

As illustrated in FIG. 7, the recognition device 100 includes an acquisition unit 110, a recognition unit 112, and a storage unit 114.

The acquisition unit 110 acquires a time-series image from a video obtained by capturing by an in-vehicle camera of an observation vehicle.

The recognition unit 112 includes a detection unit 120 and a shape recognition unit 122.

The storage unit 114 stores correspondence information regarding a target feature. The correspondence information is, for example, information for identifying the type of a font of a license plate or a sign, and information of restrictions of the number interval and the like.

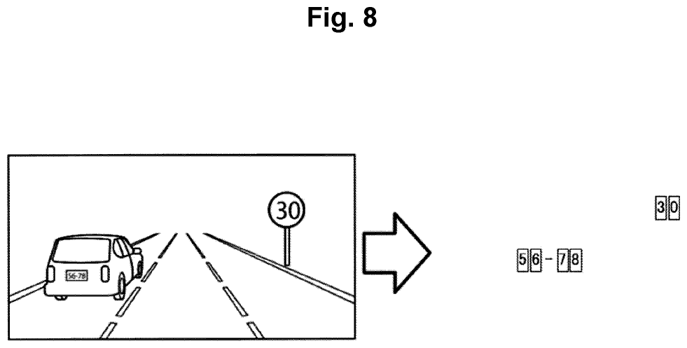

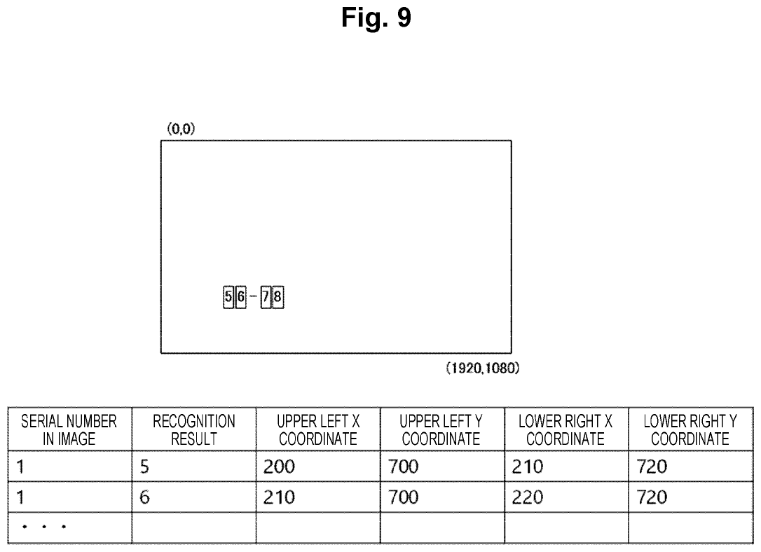

The detection unit 120 detects characters in a character string from an image. As illustrated in FIG. 8, using an object detection technology, for example, a character represented by a number (or a dot of a symbol or the like) in an image is detected by a detection rectangle representing a range of the character defined by coordinates. As illustrated in FIG. 9, the position of a character in an image can be detected as coordinates, and a detection rectangle is obtained from coordinates of points of upper left X, upper left Y, lower right X, and lower right Y.

Furthermore, in detection by the detection unit 120, characters of a character string of a specific font may be detected using a model learned in advance to detect characters of the specific font.

The shape recognition unit 122 evaluates relationship between detected characters of a character string, and recognizes a shape of a target including the character string.

An example of evaluation by the shape recognition unit 122 will be described. The shape recognition unit 122 evaluates positional relationship between detection rectangles corresponding to respective characters and evaluates relationship among pixels of the detection rectangles as evaluation regarding the relationship. Description will be made in the case of the example illustrated in FIG. 8. For the positional relationship, whether characters corresponding to a number of a license plate are recognized is evaluated. In the horizontal axis direction, the degree of closeness is evaluated. 5 and 6, 7 and 8, and 3 and 0 are close to each other in the horizontal axis direction of respective images. For four characters, the degree of separation between the second and third characters is evaluated. The interval in the horizontal axis direction between 6 and 7 is slightly longer than the intervals between 5 and 6, and 7 and 8. The position coordinates in the vertical direction of the images of the coordinates of 5, 6, 7, and 8, and the coordinates of 3 and 0 are adjacent. Therefore, the degree of adjacency is evaluated for four characters. For the relationship among the pixels, the distribution of colors in each of the detection rectangles is evaluated, and whether 5, 6, 7, and 8 are the same color and gray, and 3 and 0 are the same color and blue or a color similar to dark blue is evaluated. In the above evaluation example, for the positional relationship, a character string is recognized as a number under conditions that the intervals between the first character and the second character, and the third character and the fourth character are close in the horizontal axis direction, the degree of separation/interval between the second character and the third character of the character string satisfies the restriction, and the position coordinates in the vertical direction are adjacent. For the relationship among the pixels, a character string is recognized as a number under a condition that the pixels of the detection rectangles of four characters have the same color distribution. Furthermore, recognition may be performed in units of two characters or in units of four characters. In a case of a two-character unit, whether 5 and 6 and 7 and 8 are close to each other in the horizontal axis direction is evaluated. Furthermore, a hyphen between numbers may be considered.

Furthermore, the shape recognition unit 122 determines whether fonts of respective characters of a character string are the same, and evaluates positional relationship among fonts determined to be the same. A target may be identified from a list of features for which use of fonts is known with reference to the correspondence information in the storage unit 114. The fonts may be obtained by detection rectangles being compared further using a feature such as an aspect ratio of characters.

As described above, the shape recognition unit 122 can recognize a portion “XX-XX” corresponding to a number. Therefore, the shape recognition unit 122 may additionally recognize characters in the periphery of the portion “XX-XX” corresponding to the number. Furthermore, the shape of the target may be recognized and detected from the size of the characters. For example, in a case where it is attempted to recognize the shape of a license plate, pixels of the same color as characters of “XX-XX” may be searched for as characters in the periphery or small elements that cannot be recognized as characters, and pixels other than the number that appears on the license plate may be estimated in consideration of the presence of additional characters in the upper and left regions of “XX-XX”, the character size of the characters of “XX-XX”, here, the number of vertical and horizontal pixels of detection rectangles.

Furthermore, the shape recognition unit 122 may perform additional processing of searching the periphery of a character string of four characters corresponding to a number of a license plate, and determining that there is a region of the license plate if there is a pixel having the same color as the background of the license plate in the periphery. Note that the background of a license plate is a pixel other than pixels of characters in rectangles detected by coordinates. Furthermore, a region in which the license plate is assumed to appear may be recognized from the number of pixels of detection rectangles of four characters.

The shape recognition unit 122 recognizes a license plate as described above and identifies a region in an image in which the license plate is drawn. As described above, the recognition device 100 recognizes the shape of the license plate by the identified region and outputs the recognition result.

Note that, although a license plate has been described as an example, for example, a road sign or a road marking indicating a speed limit or the like may be set as a target. In a case of a sign illustrated in FIG. 8, characters of a character string of specific numbers such as 30 are detected. Then, the characters are evaluated, and determination of a road sign can be made by the color of the characters, the fonts, the pixel values on the concentric circles changing from white to red, and the like.

Next, operation of the recognition device 100 will be described.

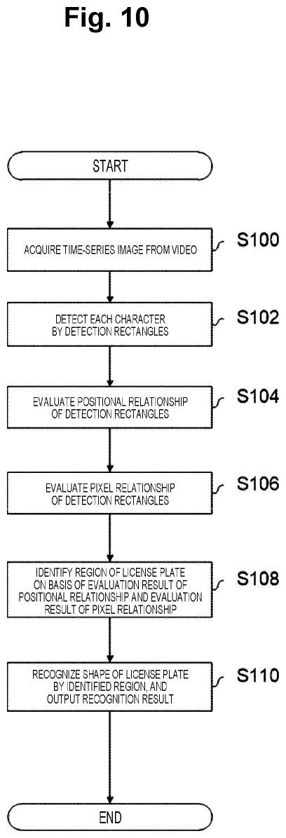

FIG. 10 is a flowchart illustrating a flow of recognition processing by the recognition device 100. The recognition processing is performed by the CPU 11 reading the recognition program from the ROM 12 or the storage 14, developing the recognition program in the RAM 13, and executing the recognition program.

In step S100, the CPU 11 as the acquisition unit 110 acquires a time-series image from a video obtained by capturing by an in-vehicle camera of an observation vehicle.

In step S102, the CPU 11 as the detection unit 120 detects each character of a character string from the image by detection rectangles.

In step S104, the CPU 11 as the shape recognition unit 122 evaluates positional relationship of the detection rectangles corresponding to respective characters of the character string.

In step S106, the CPU 11 as the shape recognition unit 122 evaluates pixel relationship of the detection rectangles.

In step S108, the CPU 11 as the shape recognition unit 122 identifies a region in the image in which a license plate is drawn on the basis of the evaluation result of the positional relationship and the evaluation result of the pixel relationship.

In step S110, the CPU 11 as the shape recognition unit 122 recognizes the shape of the license plate by the identified region and outputs the recognition result.

As described above, according to the recognition device 100 of the present embodiment, even in a case where a specific target is difficult to be recognized, detected characters can be evaluated and the target can be recognized.

Furthermore, although an example of recognizing characters including numerical values using an object detection technology has been described, another method such as pattern matching may be used. For example, a plurality of patterns is prepared, and a portion similar to a pattern is searched for in an image.

Among characters used for a license plate, dots are symbols that are used for a number uniquely in Japan and are difficult to be recognized. For example, there is no rule of setting 0 as a head as in “00-08”, and there is a rule of expressing using a dot in a case where the head is 0 as in “ . . . 8”, “ . . . 28”, and “⋅1-28”. Therefore, as a modification, the object detection technology may be applied only to a number and dots may be individually searched for. In a case where a detected number is one character, three pixel regions of a pattern that may be regarded as a dot in corresponding pixels in the “left” are searched for in consideration of a hyphen region. Then, for example, peripheral regions to be dot possibilities are binarized, and whether the centers are black pixels and the others are white pixels is determined to detect the dots. In a case where the number of detected characters is two, the search range is two portions. In a case where the number of detected characters is three, the search range is one portion.

Furthermore, although an example of using an in-vehicle camera has been described, any camera may be used as long as the camera captures an environment in which a vehicle travels. A fixed monitoring camera installed above an intersection or in a parking lot, or a capturing device for identifying a speeding vehicle may be used, or a monitoring camera installed on a sidewalk or a storefront may be used. In this case, since there is a possibility that a license plate, a road sign, and the like are not directly in front but are inclined, the shape may be recognized by a portion extending vertically or horizontally or a bent portion being corrected in consideration of the aspect ratio of detected characters and numbers. In evaluation of relationship among detection rectangles, the aspect ratio per character of the target may be considered.

Note that the recognition processing executed by the CPU reading software (program) in the above embodiment may be executed by various processors other than the CPU. Examples of the processors in this case include a programmable logic device (PLD) whose circuit configuration can be changed after manufacturing, such as a field-programmable gate array (FPGA), and a dedicated electric circuit that is a processor having a circuit configuration exclusively designed for executing specific processing, such as an application specific integrated circuit (ASIC). In addition, the recognition processing may be executed by one of these various processors, or may be executed by a combination of two or more processors of the same type or different types (for example, a plurality of FPGAs, a combination of a CPU and an FPGA, or the like). Further, a hardware structure of the various processors is, more specifically, an electric circuit in which circuit elements such as semiconductor elements are combined.

In the above embodiment, the aspect in which the recognition program is stored (installed) in advance in the storage 14 has been described, but the present invention is not limited thereto. The program may be provided by being stored in a non-transitory storage medium such as a compact disk read only memory (CD-ROM), a digital versatile disk read only memory (DVD-ROM), and a universal serial bus (USB) memory. The program may be downloaded from an external device via a network.

Regarding the above embodiment, the following supplementary notes are further disclosed.

### SUPPLEMENTARY NOTE 1

A recognition device including:
a memory; and
at least one processor connected to the memory,
in which the processor acquires a time-series image acquired in an environment in which a vehicle travels,
detects characters of a predetermined character string from the image, and
evaluates relationship between detected characters of the character string and recognizes a shape of a target including the character string.

### SUPPLEMENTARY NOTE 2

A non-transitory storage medium that stores a program executable by a computer to execute recognition processing,
in which the non-transitory storage medium acquires a time-series image acquired in an environment in which a vehicle travels,
detects characters of a predetermined character string from the image, and
evaluates relationship between detected characters of the character string and recognizing a shape of a target including the character string.

1. A recognition device comprising:
a memory; and
at least one processor coupled to the memory, the at least one processor being configured to:
acquire a time-series image acquired in an environment in which a vehicle travels;
detect characters of a predetermined character string from the image; and
evaluate relationship between detected characters of the character string and recognize a shape of a target including the character string.

2. The recognition device according to claim 1,
wherein the processor is configured to obtain the image by capturing by an in-vehicle camera is used as the image, and
recognize a shape of the target by identifying a region in an image in which the target is drawn with at least one of a license plate or a sign set as the target.

3. The recognition device according to claim 1,
wherein the processor is configured to evaluate positional relationship for relationship between the characters.

4. The recognition device according to claim 1,
wherein the processor is configured to determine whether fonts of respective characters of the character string are same, and evaluate positional relationship between fonts determined to be same.

5. The recognition device according to claim 1,
wherein the processor is configured to detect a detection rectangle representing a range of a character defined by coordinates of each of the characters, and
evaluate relationship between a pixel of a character and a pixel other than a character in the detection rectangle.

6. The recognition device according to claim 1,
wherein the processor is configured to detect characters of the character string using a model learned in advance to detect a character of a specific font.

7. A recognition method for causing a computer to execute processing, the processing comprising:
acquiring a time-series image acquired in an environment in which a vehicle travels;
detecting characters of a predetermined character string from the image; and
evaluating relationship between detected characters of the character string and recognizing a shape of a target including the character string.

8. A non-transitory, computer-readable storage medium storing a recognition program for causing a computer to execute processing, the processing comprising:
acquiring a time-series image acquired in an environment in which a vehicle travels;
detecting characters of a predetermined character string from the image; and
evaluating relationship between detected characters of the character string and recognizing a shape of a target including the character string.
